(19) United States
(12) Patent Application Publication
(10) Pub. No.: US 2026/0093463 A1
(43) Pub. Date: Apr. 2, 2026

(54) Method for Transforming a Code Using a Large Language Model

(71) Applicant: Robert Bosch GmbH, Stuttgart (DE)

(72) Inventors: Andrea Flexeder, Erdmannhausen (DE); Jesko Hecking-Harbusch, Leonberg (DE); Jochen Quante, Ludwigsburg (DE); Martin Leinberger, Koblenz (DE); Matthias Woehrle, Bietigheim-Bissingen (DE)

(21) Appl. No.: 19/342,505

(22) Filed: Sep. 27, 2025

(30) Foreign Application Priority Data
Sep. 30, 2024 (DE) 10 2024 209 514.1

(51) Int. Cl. G06F 8/35

(52) U.S. Cl. CPC G06F 8/35

(57) ABSTRACT

A method for transforming a code using a large language model includes (i) extracting a code snippet to be transformed from a code, (ii) transforming the extracted code snippet by the large language model, (iii) checking the transformed code snippet based on at least one defined requirement, and (iv) integrating the transformed code snippet into the code if a result of the check indicates that the at least one defined requirement is met. A computer program, a device, and a storage medium for this purpose are also disclosed.

This application claims priority under 35 U.S.C. § 119 to application no. DE 10 2024 209 514.1, filed on Sep. 30, 2024 in Germany, the disclosure of which is incorporated herein by reference in its entirety.

The disclosure relates to a method for transforming a code using a large language model. The disclosure further relates to a computer program, a device, and a storage medium for this purpose.

### BACKGROUND

Large language models (LLMs) can perform tasks on existing program code using appropriate text prompts. For example, code can be improved, errors corrected, or translated from one programming language to another. However, the results delivered by the LLM are often incorrect or do not meet the desired quality criteria (keyword: hallucination). For example, refactoring is intended to improve the quality of a code construct (e.g., in terms of readability or maintainability) while maintaining its behavior. However, if refactoring is performed by an LLM, the behavior often changes—so that it is no longer refactoring. In this way, subtle errors may be introduced that later lead to problems and have to be corrected at great expense. The larger the input—in this case, the code to be processed—the more frequently an LLM delivers such incorrect results.

The challenge of having to guarantee correctness is particularly important in safety-relevant systems. Such technologies cannot be used in the development of such systems without sound validation.

A certain context is necessary for an LLM to fulfill the tasks described above correctly. This includes, for example, declarations of the program constructs that are used in the corresponding code. This means that it is not enough to simply provide the relevant function, for example, the type, variables and other declarations used in the function must also be provided. This significantly increases the required context input size, possibly by an order of magnitude. As a result, the LLM reaches its limits even faster and cannot focus on the actually relevant part, which often only comprises a few lines of code. This increases the frequency of errors.

On the other hand, functions often contain complex control constructs (e.g. nested loops and branches) that cause scaling problems when checked with formal methods. In many cases, the formal method cannot deliver a verification result in an acceptable time (e.g. a few minutes).

### SUMMARY

The subject-matter of the disclosure is a method, a computer program, a device, and a computer-readable storage medium having the features set forth below. Further features and details of the disclosure will emerge from the description and the drawings. Features and details which are described in connection with the method according to the disclosure naturally also apply in connection with the computer program according to the disclosure, the device according to the disclosure, and the computer-readable storage medium according to the disclosure, and vice versa in each case, so that a reciprocal reference is always possible with regard to the disclosure of the disclosure.

The object of the disclosure is, in particular, a method for transforming a code by a large language model, comprising the following steps:
extracting a code snippet to be transformed from a code, wherein the code snippet to be transformed is determined manually or automatically, e.g. due to an error when executing the code or in order to refactor the code snippet, for example to improve the readability or maintainability of the code snippet,
transforming the extracted code snippet by the large language model, wherein the extracted code snippet is improved during the transforming process, for example with regard to at least one property such as scarcity or maintainability, and/or at least one error in the extracted code snippet is corrected, and/or the extracted code snippet is translated from one programming language into another programming language,
checking the transformed code snippet on the basis of at least one defined requirement, wherein preferably at least one or more check procedures can be carried out, wherein, for example, it can be checked whether an error of the original extracted code snippet is still present and/or whether the transformed code snippet leads to an error message and/or whether the transformed code snippet produces the same output as the original extracted code snippet,
integrating the transformed code snippet into the code, i.e. in particular into the original code, if a result of the check indicates that the at least one defined requirement is fulfilled.

When extracting the code snippet to be transformed from the code, it is preferable to extract not just the lines that are affected, for example, but also the required context. As a result, the extracted code snippet must contain the relevant code and be translatable. According to the disclosure, the extracted code snippet can thus be isolated into a translatable form and transformed separately by the large language model. This is particularly advantageous if the code from which the code snippet is extracted is very extensive. This isolation can enable more targeted processing and reduction of errors, as the focus is on this specific area. The formal check ensures in particular that the transformation meets at least one defined requirement and generates correct code. Only if the check is successful is the transformed code snippet preferably integrated into the original code, which can improve the accuracy of the entire transformation process.

The at least one defined requirement may include, for example, semantic consistency and/or equivalence, i.e. in particular the same behavior as the originally extracted code snippet, syntactic correctness and/or at least one rule-based restriction of the code, for example based on a standard or other context of the code.

It may further be possible that, if the result of the check indicates that the at least one defined requirement is not met, the steps of transforming and checking are performed again until the result of the check indicates that the at least one defined requirement is met. Repeated execution of the transforming and checking process can therefore ensure that the transformed code snippet meets at least one defined requirement. In particular, this increases the reliability of the resulting code and can reduce errors that could arise due to inadequate transformation results.

It is also conceivable, as an option, that the transformation carried out again in each case also comprises the following step:
determining a text prompt comprising a respective previous result of transforming and checking, wherein, based on the text prompt, a correction of the respective previous result of transforming is initiated by the large language model.

In particular, this ensures that the large language model iteratively improves its output. The combination of the transformed code snippet and the result of the check can also be used to fine-tune the large language model step by step. This can lead to greater accuracy and reliability when transforming.

It is also conceivable within the scope of the disclosure that the extraction comprises the following steps:
Determination of an abstract syntax tree (AST) of the code,
analyzing the determined abstract syntax tree, especially with regard to context information in the code for the extracted code snippet,
inserting at least one addition into the extracted code snippet based on a result of the analyzing, in particular to provide the context information enabling isolated translation, testing and/or execution of the extracted code snippet in terms of the code.

An abstract syntax tree is, in particular, a data structure that can be used to represent an abstract syntactic structure of program code. It is preferably a tree structure that represents the code in a hierarchical form and can make it possible to analyze and process the code on an abstract level. The abstract syntax tree is generated, for example, by a parser of a compiler or interpreter and includes in particular all information about the structure of the code, including the arrangement of expressions, instructions and operators.

Optionally, it may be provided that analyzing the determined abstract syntax tree comprises the following steps:
analyzing the abstract syntax tree to determine nodes in the abstract syntax tree that are assigned to the extracted code snippet,
determining a parent node of the determined nodes of the extracted code snippet,
determining nodes of the abstract syntax tree that are present below the parent node and do not belong to the specific nodes of the extracted code snippet.

In particular, this ensures that the large language model precisely determines the code snippet to be transformed, which can improve the quality of the transformation. Analysis of the abstract syntax tree may also allow a better understanding of the context of the code snippet being transformed, which may also improve the accuracy of the transformation.

It is also optionally conceivable that the insertion of the at least one supplement into the extracted code snippet comprises at least one of the following steps:
Insertion of artificially generated code in order to adapt the runtime behavior of the extracted code snippet to the code, i.e. in particular the original code,
inserting declarations from the code that affect the extracted code snippet.

This allows the extracted code snippet to be precisely adapted to an original behavior in the code's environment, so that the transformation by the large language model can be carried out more precisely and an analysis by static or dynamic methods is possible.

In a further possibility, it may be provided that the method is carried out automatically and the at least one requirement comprises at least one requirement from a standard, in particular MISRA-C. MISRA C is in particular a C programming standard from the automotive industry, which was developed by the English MISRA (Motor Industry Software Reliability Association). The inclusion of standards such as MISRA-C ensures in particular that the resulting code also fulfills common safety and quality specifications. This can improve the reliability and security of the resulting code.

Extraction can also be carried out on the basis of an error in a technical system. In this case, the at least one defined requirement can at least relate to rectifying the error in the technical system. In other words, a corresponding code snippet is extracted that leads to the error in the technical system and at least one defined requirement can be used to check whether the error has been rectified.

Another object of the disclosure is a computer program, in particular a computer program product, comprising commands which, when the computer program is executed by a computer, cause the computer to carry out the method according to the disclosure. The computer program according to the disclosure thus brings with it the same advantages as have been described in detail with reference to a method according to the disclosure.

The disclosure also relates to a device for data processing which is configured so as to carry out the method according to the disclosure. The device can be a computer, for example, that executes the computer program according to the disclosure. The computer can comprise at least one processor for executing the computer program. A non-volatile data memory can be provided as well, in which the computer program can be stored and from which the computer program can be read by the processor for execution.

The disclosure can also relate to a computer-readable storage medium, which comprises the computer program according to the disclosure and/or commands that, when executed by a computer, prompt said computer program to carry out the method according to the disclosure. The storage medium is configured as a data memory such as a hard drive and/or a non-volatile memory and/or a memory card, for example. The storage medium can, for example, be integrated into the computer.

In addition, the method according to the disclosure can also be designed as a computer-implemented method. Alternatively or additionally, at least one of the disclosed method steps may be computer-implemented and/or performed automatically.

### BRIEF DESCRIPTION OF THE DRAWINGS

Further advantages, features, and details of the disclosure emerge from the following description, in which exemplary embodiments of the disclosure are described in detail with reference to the drawings. The features mentioned in the claims and in the description can each be essential to the disclosure individually or in any combination. The figures show:

FIG. 1 a schematic visualization of a method, a technical system, a large language model, a device, a storage medium, and a computer program according to exemplary embodiments of the disclosure,

FIG. 2 a schematic illustration of an abstract syntax tree according to exemplary embodiments of the disclosure,

FIG. 3 a schematic illustration of an abstract syntax tree according to exemplary embodiments of the disclosure,

FIG. 4 a schematic illustration of an abstract syntax tree according to exemplary embodiments of the disclosure,

FIG. 5 a schematic illustration of an abstract syntax tree according to exemplary embodiments of the disclosure, and

FIG. 6 a schematic illustration of an abstract syntax tree according to exemplary embodiments of the disclosure.

### DETAILED DESCRIPTION

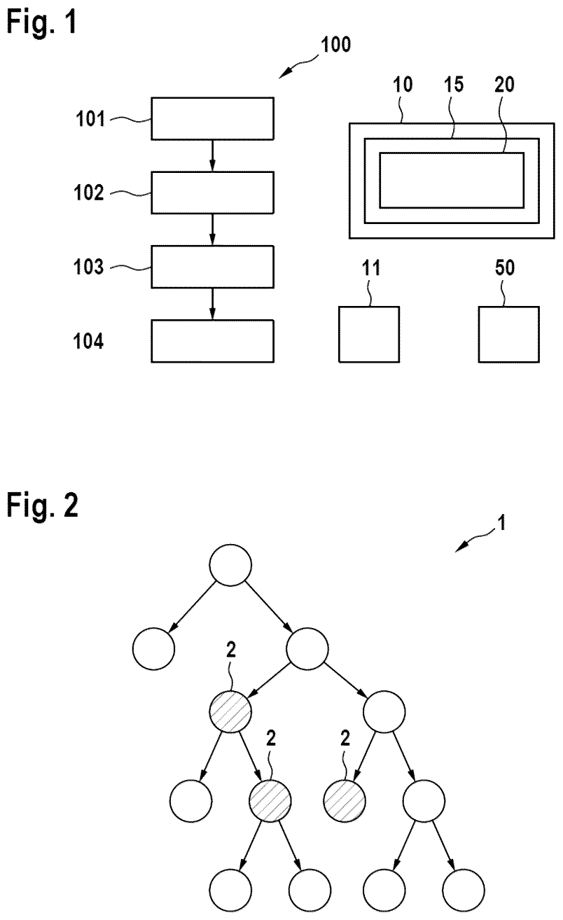

FIG. 1 schematically illustrates a method 100, a technical system 11, a large language model 50, a device 10, a storage medium 15, and a computer program 20 according to exemplary embodiments of the disclosure.

In particular, FIG. 1 shows a method 100 for transforming a code by a large language model 50. In a first step 101, a code snippet to be transformed is extracted from a code. In a second step 102, the extracted code snippet is transformed by the large language model 50. In a third step 103, the transformed code snippet is checked on the basis of at least one defined requirement. In a fourth step 104, the transformed code snippet is integrated into the code if a result of the checking 103 indicates that the at least one defined requirement is fulfilled.

FIG. 2 shows a determination of nodes 2 of the abstract syntax tree 1 for the relevant lines of code. A set K comprises these specific nodes 2.

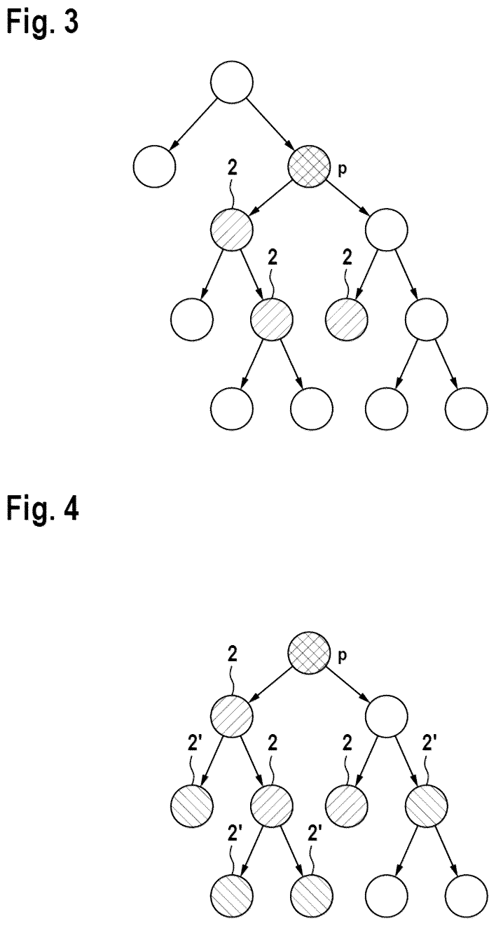

FIG. 3 shows a determination of a common parent node p of the determined nodes 2.

FIG. 4 schematically shows a determination of nodes 2′ whose entire subtree is not in K. A set N comprises these nodes 2′.

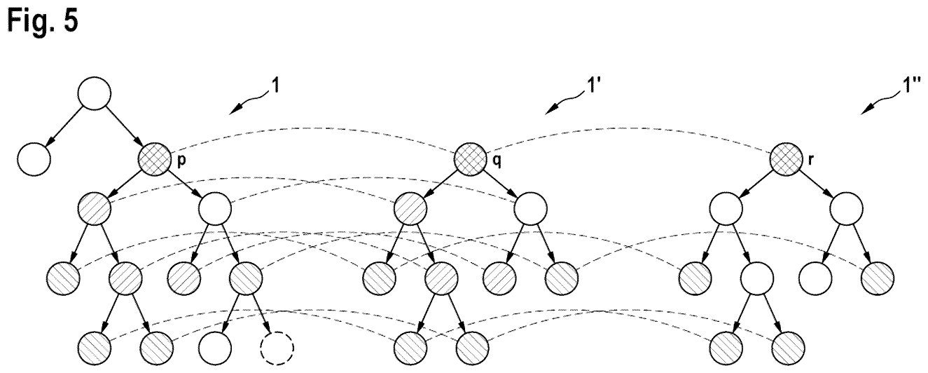

FIG. 5 shows mappings between partial trees p and q, and q and r. In particular, p is the partial tree of the original code, q is the partial tree of the isolated code, and r is the partial tree of the transformed code.

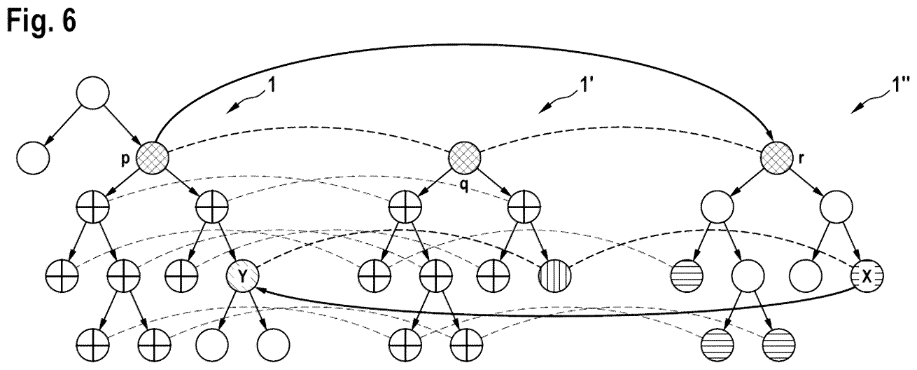

FIG. 6 shows a determination of a resulting code using the partial trees. In particular, r is inserted instead of p and y is inserted instead of x. Similarly, nodes from r are preferably replaced by partial trees of p (not shown).

Reference will be made again to FIGS. 2 to 6 in the detailed description below.

According to exemplary embodiments of the disclosure, the code parts relevant for the change are isolated before the actual processing. Then, in particular, the large language model-based transformation is performed. A result is then preferably checked on the basis of at least one defined requirement, i.e., verified using formal methods. Finally, the change, i.e., in particular the transformed code snippet, is preferably incorporated into the original code.

The problem (i.e. the code) is reduced to a code snippet relevant to the change. The large language model can therefore focus better on this code snippet and can therefore provide better results. The formal method, i.e. checking, does not run into a scaling problem, which is particularly advantageous due to the low complexity of the code snippet.

Input data is preferably a translatable code and a change task to be performed by a large language model on a particular part of the code, that is, the code snippet. Furthermore, a formal method or an executable tool that implements this method is preferably provided, which can check the quality of the result.

The affected lines of the code snippet are preferably extracted and supplemented by analyzing the abstract syntax tree 1 (AST) of the code in such a way that valid code is created again that includes these lines. The abstract syntax tree 1 for the given (overall) input code can be determined first. Subsequently, node 2 of the abstract syntax tree 1 can be determined, which belong to the lines of the code snippet. In particular, these form the set K (see FIG. 2). A (first) common parent node p of all nodes in K is then preferably determined (see FIG. 3), which is preferably an instruction (i.e. expressions are preferably retained). Subsequently, nodes 2′ of the abstract syntax tree below the parent node p are preferably determined, from which the entire subtree is not in K (see FIG. 4). These elements, or nodes 2′, form in particular a set N and are preferably replaced by an artificially generated code in a step described below. A function with corresponding interfaces is then preferably generated around the code that is attached to the parent node p. The code belonging to node 2, which is attached to p, can then be inserted up to node 2′ in N. Preferably, artificially generated code is inserted in their place, which marks the achievement of this position at runtime, e.g. by setting a variable to a unique constant value. Furthermore, required declarations that occur before the function in the generated code can be inserted.

The large language model-based transformation is then preferably performed on the extracted code snippet.

A result of the large language model-based transformation is then preferably checked. If the check fails, this is preferably reported back to the large language model 50 and a correction is initiated. The response from large language model 50 can then be used to perform the large language model-based transformation again.

If the check is successful, the change that the large language model 50 has made to the isolated code snippet is preferably applied to the original code, i.e. integrated into it. Preferably, the abstract syntax tree 1 of the original function, the node p, the abstract syntax tree 1′ of the extracted function and the abstract syntax tree 1″ of the function modified by the large language model 50 are calculated (see FIG. 5). Furthermore, a node q in the abstract syntax tree 1′ is preferably determined, which corresponds to the node p in the abstract syntax tree 1, and a node r in the abstract syntax tree 1″, which corresponds to the node q in the abstract syntax tree 1′ (see FIG. 5, yellow nodes). This is done, for example, via a node type and a position in the abstract syntax tree. Subsequently, similarities and differences between the subtrees p and q can be determined (see FIG. 5, left pair). This allows a mapping Tba of the inserted placeholders, i.e. the artificially generated code, to the original code (from the abstract syntax tree 1) to be determined. Furthermore, similarities and differences between the subtrees q and r can be determined (see FIG. 5, right pair). In particular, this determines a mapping Tcb of the placeholders in the abstract syntax tree 1″ to the placeholders in the abstract syntax tree 1′. The transformed code can then be generated from the abstract syntax tree 1 by traversing and unparsing the individual nodes n using the function Tcb (Tba (n)), provided this is defined there (see FIG. 6).

In the following, the method according to exemplary embodiments of the disclosure is described using one example.

The following C-code is given:

void func(unsigned int val) {
// more code A
if (val != 0) {
// more code B
}
else {
// more code C
}
// more code D
}

For example, MISRA-C requires that the types on both sides of the operator are the same for mathematical operations. In the example, val is an unsigned int, but the literal 0 is int (by default). To solve this problem, the corresponding line is preferably isolated. Starting from the expression val!=0, the if statement can be determined as node p. The entire then block and the else block (“more code B” and “more code C”) can be determined as set N. A new function is now preferably generated that contains exactly this code:

unsigned int val;
int foo( ) {
int ret = 0;
if (val != 0) {
ret = 1;
}
else {
ret = 2;
}
return ret;
}

The instructions regarding ret are preferably generated for the nodes in N. They help in particular with the formal review to characterize the behavior. The declaration of val can also be generated. The large language model-based transformation on this code could lead to the following result:

unsigned int val;
int foo( ) {
int ret = 0;
if (val != 0u) {
ret = 1;
}
else {
ret = 2;
}
return ret;
}

It can now be checked and concluded that this code no longer covers the original problem. In the next step, the code change can now be incorporated into the original code:

void func(unsigned int val) {
// more code A
if (val != 0u) {
// more code B
}
else {
// more code C
}
// more code D
}

The above explanation of the embodiments describes the present disclosure solely within the scope of examples. Of course, individual features of the embodiments can be freely combined with one another, if technically feasible, without leaving the scope of the present disclosure.

What is claimed is:

1. A method for transforming a code using a large language model, comprising:
extracting a code snippet to be transformed from a code;
transforming the extracted code snippet by the large language model;
checking the transformed code snippet based on at least one defined requirement; and
integrating the transformed code snippet into the code if a result of the check indicates that the at least one defined requirement is met.

2. The method according to claim 1, wherein:
if the result of the check indicates that the at least one defined requirement is not met, the steps of transforming and checking are performed again until the result of the check indicates that the at least one defined requirement is met.

3. The method according to claim 2, wherein the respective repeated transformation further comprises:
determining a text prompt comprising a respective previous result of transforming and checking, wherein, based on the text prompt, a correction of the respective previous result of transforming is initiated by the large language model.

4. The method according to claim 1, wherein the at least one defined requirement comprises semantic consistency and/or equivalence, syntactic correctness and/or at least one rule-based restriction of the code.

5. The method according to claim 1, wherein the extracting step comprises the following:
determining an abstract syntax tree of the code,
analyzing the determined abstract syntax tree, and
inserting at least one addition into the extracted code snippet based on a result of the analysis.

6. The method according to claim 5, wherein analyzing the determined abstract syntax tree comprises:
analyzing the abstract syntax tree to determine nodes in the abstract syntax tree that are assigned to the extracted code snippet,
determining a parent node of the determined nodes of the extracted code snippet, and
determining nodes of the abstract syntax tree that are present below the parent node and do not belong to the specific nodes of the extracted code snippet.

7. The method according to claim 5, wherein inserting the at least one supplement into the extracted code snippet comprises at least one of the following:
inserting artificially generated code to adapt the runtime behavior of the extracted code snippet to the code, and
inserting declarations from the code that affect the extracted code snippet.

8. The method according to claim 1, wherein the method is carried out automatically and the at least one requirement comprises at least one requirement from a standard.

9. The method according to claim 1, wherein the extraction is performed based on an error in a technical system and the at least one defined requirement relates at least to rectifying the error in the technical system.

10. A computer program, comprising instructions that, when the computer program is executed by a computer, cause the computer to carry out the method according to claim 1.

11. A device for data processing, configured so as to carry out the method according to claim 1.

12. A computer-readable storage medium comprising instructions which, when executed by a computer, cause it to carry out the steps of the method according to claim 1.

13. The method according to claim 8, wherein the standard is MISRA-C.
